(19) United States
(12) Patent Application Publication
(10) Pub. No.: US 2026/0194727 A1
(43) Pub. Date: Jul. 9, 2026

(54) TELECOMMUNICATIONS RACK AND METHOD FOR ROUTING

(71) Applicant: AFL Telecommunications LLC, Duncan, SC (US)

(72) Inventors: Soma Shekar Gandla, Milton Keynes (GB); Asher Leong Raven, Milton Keynes (GB); Keith Sullivan, Kent (GB)

(21) Appl. No.: 19/129,479

(22) PCT Filed: Nov. 9, 2023
(86) PCT No.: PCT/US2023/079210

§ 371 Date: May 13, 2025

Related U.S. Application Data
(60) Provisional application No. 63/425,519, filed on Nov. 15, 2022.

(51) Int. Cl. G02B 6/44

(52) U.S. Cl. CPC G02B 6/44524; G02B 6/44528; G02B 6/4453

(57) ABSTRACT

An apparatus for telecommunications equipment mounting is provided, including a frame, a cabinet, and a plurality of patch trays. The cabinet is releasably attachable to the frame and forms a volume positioned adjacent along a vertical direction to a cabinet base wall separating the cabinet into a first volume and a second volume. The plurality of patch trays is releasably attachable to the cabinet at the first volume and includes a body having a plurality of tray sidewalls and a tray base wall. The plurality of sidewalls and the base wall form an interior at which an adapter bank is positioned. An opening is positioned at a bottom outside portion of the body relative to a transverse direction of the apparatus. The opening is adjacent along the vertical direction to the second volume formed at the cabinet.

### PRIORITY STATEMENT

The present application claims the benefit of priority to U.S. provisional application No. 63/425,519, titled “OSP CABLE DEMARCATION RACKS” and filed on Nov. 15, 2022, the disclosure of which is incorporated by reference herein in its entirety.

### FIELD

The present disclosure relates generally to structures for telecommunications cables, and more particularly, to cable demarcation racks.

### BACKGROUND

Speed of deployment of optical networks is critical for organizations to begin earning revenue from their capital expenditure. As such some methods of deploying optical networks, specifically splicing, requires skilled labor and can be time consuming, approximately 5 minutes per 12 fiber ribbon splice. Current applications utilize external (outside the building) enclosures, or internal structures to perform this splicing. An impact of the use of internal structures is that space available for revenue generating IT equipment is utilized to perform the splicing. External enclosures require a ‘pit’ and are liable to flooding meaning remedial work can be challenging.

Accordingly, improved methods and apparatus that facilitate improved optical network deployment and/or address one or more above identified issues are desired in the art and would be advantageous.

### BRIEF DESCRIPTION

Aspects and advantages of the invention will be set forth in part in the following description, may be apparent from the description, or may be learned through practice of the invention.

An aspect of the present disclosure is directed to an apparatus for telecommunications equipment mounting, including a frame, a cabinet, and a plurality of patch trays. The cabinet is releasably attachable to the frame and forms a volume positioned adjacent along a vertical direction to a cabinet base wall separating the cabinet into a first volume and a second volume. The plurality of patch trays is releasably attachable to the cabinet at the first volume and includes a body having a plurality of tray sidewalls and a tray base wall. The plurality of sidewalls and the base wall form an interior at which an adapter bank is positioned. An opening is positioned at a bottom outside portion of the body relative to a transverse direction of the apparatus. The opening is adjacent along the vertical direction to the second volume formed at the cabinet.

Another aspect of the present disclosure is directed to a method for telecommunications cable routing. The method includes extending a pre-terminated cable assembly through a frame to a volume within the frame; extending fanout cable assembly portions of the pre-terminated cable assembly from the volume within the frame into respective cabinet volumes in fluid communication with respective patch tray arrays; extending respective fanout cable assembly portions of the pre-terminated cable assembly from the cabinet volume into one or more patch trays of the patch tray array corresponding to the cabinet volume; operably coupling the fanout cable assembly to the patch tray; and extending an output cable assembly from the patch tray to the cabinet volume corresponding to the respective fanout cable assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1A is a perspective view from a front end of an exemplary telecommunications equipment mounting structure in accordance with aspects of the present disclosure;

FIG. 1B is a rear side view of an exemplary telecommunications equipment mounting structure in accordance with aspects of the present disclosure;

FIG. 2 is a perspective view from a rear end of an exemplary telecommunications equipment mounting structure in accordance with aspects of the present disclosure;

FIG. 3 is a rear side view of an exemplary telecommunications equipment mounting structure with doors closed in accordance with aspects of the present disclosure;

FIG. 4 is a perspective view from a front end of an exemplary telecommunications equipment mounting structure with patch panels removed in accordance with aspects of the present disclosure;

FIG. 5 is an exploded perspective view from a rear end of an exemplary telecommunications equipment mounting structure with patch panels removed in accordance with aspects of the present disclosure;

FIG. 6A is a perspective view of an exemplary cabinet of the telecommunications equipment mounting structure in accordance with aspects of the present disclosure;

FIG. 6B is a detailed view of a patch tray array, with a patch tray in an open position, of the cabinet of FIG. 6A in accordance with aspects of the present disclosure;

FIG. 7 is a detailed view of a portion of the telecommunications equipment mounting structure in accordance with aspects of the present disclosure;

FIG. 8 is a detailed view of a portion of the telecommunications equipment mounting structure, with a patch tray in an open position, in accordance with aspects of the present disclosure;

FIG. 9 is a detailed perspective view of a portion of the telecommunications equipment mounting structure in accordance with aspects of the present disclosure;

FIG. 10 is a detailed perspective view of a portion of the telecommunications equipment mounting structure in accordance with aspects of the present disclosure;

FIG. 11 is a detailed view of a portion of the telecommunications equipment mounting structure in accordance with aspects of the present disclosure;

FIG. 12 is a perspective view of an embodiment of a patch tray of the telecommunications equipment mounting structure in accordance with aspects of the present disclosure;

FIG. 13 is an exploded view of an embodiment of a patch tray of the telecommunications equipment mounting structure in accordance with aspects of the present disclosure;

FIG. 14 is a plan view of an embodiment of a patch tray of the telecommunications equipment mounting structure in accordance with aspects of the present disclosure;

FIG. 15 is a perspective view of an embodiment of a splice enclosure of the telecommunications equipment mounting structure in accordance with aspects of the present disclosure;

FIG. 16A is a view from a rear end of an exemplary telecommunications equipment mounting structure in accordance with aspects of the present disclosure;

FIG. 16B is a view from the rear end of the exemplary telecommunications equipment mounting structure of FIG. 16A in accordance with aspects of the present disclosure;

FIG. 17A is a perspective view of an exemplary telecommunications equipment mounting structure in accordance with aspects of the present disclosure;

FIG. 17B is a detailed perspective view of an exemplary patch array of an exemplary telecommunications equipment mounting structure of FIG. 17A in accordance with aspects of the present disclosure;

FIG. 18A is a rear view of an exemplary telecommunications equipment mounting structure depicting an exemplary method for cable routing in accordance with aspects of the present disclosure;

FIG. 18B depicts an exemplary telecommunications cable for embodiments of the telecommunications equipment mounting structure and methods for cable routing in accordance with aspects of the present disclosure;

FIG. 18C depicts a detailed view of the exemplary telecommunications cable of FIG. 18B in accordance with aspects of the present disclosure;

FIG. 18D depicts a perspective view of a portion of an exemplary telecommunications equipment mounting structure including an exemplary patch tray at which a telecommunications cable operably couples in accordance with aspects of the present disclosure;

FIG. 19A is an internal rear side view of an exemplary telecommunications equipment mounting structure depicting an exemplary method for cable routing in accordance with aspects of the present disclosure;

FIG. 19B is a side view of an exemplary telecommunications equipment mounting structure of FIG. 19A depicting an exemplary method for cable routing in accordance with aspects of the present disclosure;

FIG. 20A depicts a first routing method of a cable at an exemplary embodiment of the telecommunications equipment mounting structure in accordance with aspects of the present disclosure;

FIG. 20B depicts a second routing method of a cable at an exemplary embodiment of the telecommunications equipment mounting structure in accordance with aspects of the present disclosure;

FIG. 20C depicts a third routing method of a cable at an exemplary embodiment of the telecommunications equipment mounting structure in accordance with aspects of the present disclosure;

FIG. 20D depicts a fourth routing method of a cable at an exemplary embodiment of the telecommunications equipment mounting structure in accordance with aspects of the present disclosure;

FIG. 20E depicts a fifth routing method of a cable at an exemplary embodiment of the telecommunications equipment mounting structure in accordance with aspects of the present disclosure;

FIG. 20F depicts a sixth routing method of a cable at an exemplary embodiment of the telecommunications equipment mounting structure in accordance with aspects of the present disclosure;

FIG. 20G depicts a seventh routing method of a cable at an exemplary embodiment of the telecommunications equipment mounting structure in accordance with aspects of the present disclosure;

FIG. 20H depicts a eighth routing method of a cable at an exemplary embodiment of the telecommunications equipment mounting structure in accordance with aspects of the present disclosure;

FIG. 20I depicts a ninth routing method of a cable at an exemplary embodiment of the telecommunications equipment mounting structure in accordance with aspects of the present disclosure;

FIG. 20J depicts a tenth routing method of a cable at an exemplary embodiment of the telecommunications equipment mounting structure in accordance with aspects of the present disclosure;

FIG. 20K depicts a eleventh routing method of a cable at an exemplary embodiment of the telecommunications equipment mounting structure in accordance with aspects of the present disclosure;

FIG. 20L depicts a twelfth routing method of a cable at an exemplary embodiment of the telecommunications equipment mounting structure in accordance with aspects of the present disclosure;

FIG. 21 depicts an exemplary method for routing and connection of telecommunications cables in accordance with aspects of the present disclosure;

FIG. 22 provides a flowchart outlining steps for a method for routing and connection of telecommunications cables in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Dimensions provided herein may include approximations of +/−2% of any discrete quantity, or approximations of +2% of a maximum value over a given range or −2% of the maximum value under the given range, unless otherwise provided herein.

As used herein, the term “rack unit” (RU) is understood by those skilled in the art as a unit of measure of approximately 1.75 inches (in) or approximately 44.45 millimeters (mm), or up to 0.03125 in or 0.794 mm less when applied to telecommunications equipment attached to a mount structure.

As used herein, “fluid communication” refers to flow, egress, passage, or routing between partially or fully enclosed volumes, or from an exterior (e.g., volumes outside of the apparatus 100) to a partially or fully enclosed volume. “Direct fluid communication” refers to fluid communication without intermediate passages, conduits, manifolds, enclosures, or other bounded spaces therebetween.

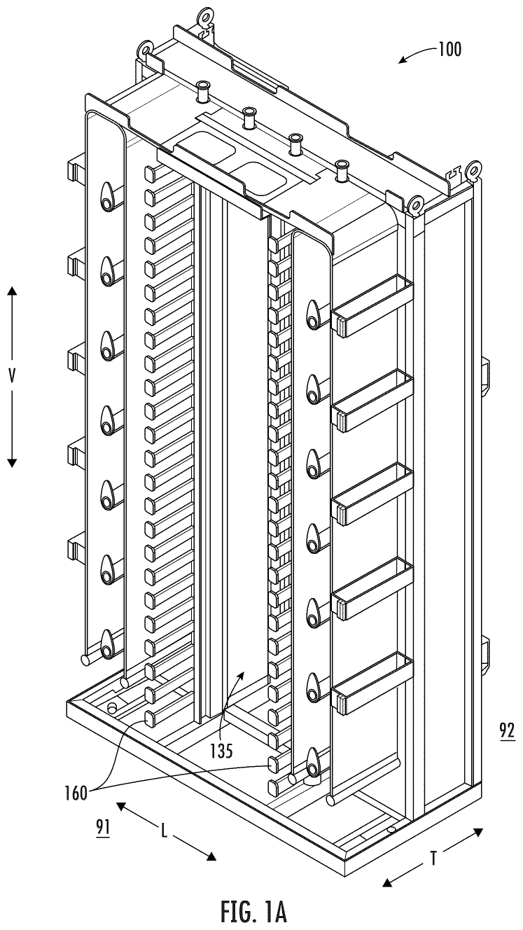

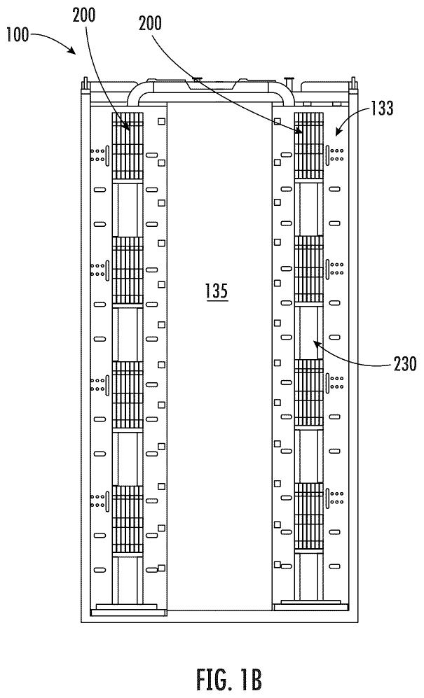

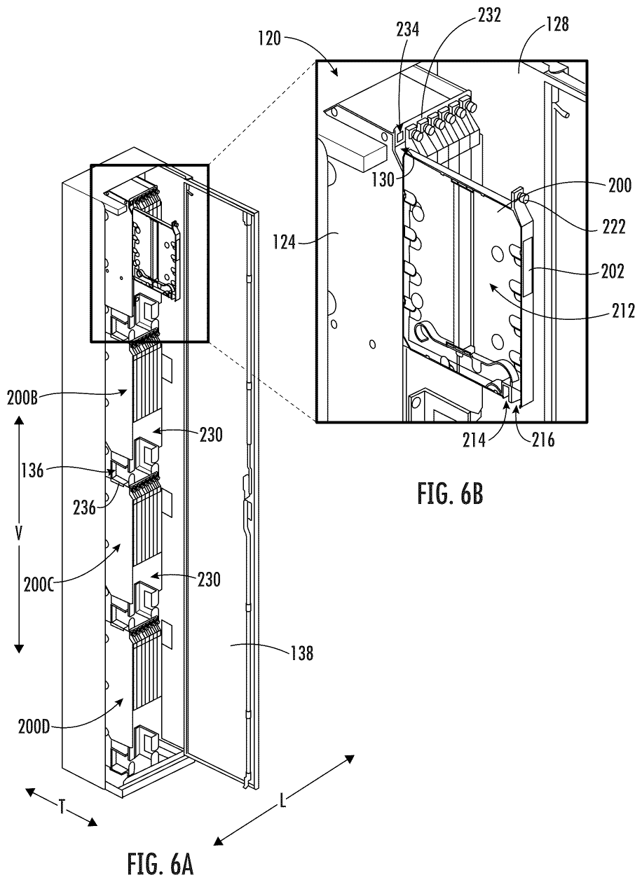

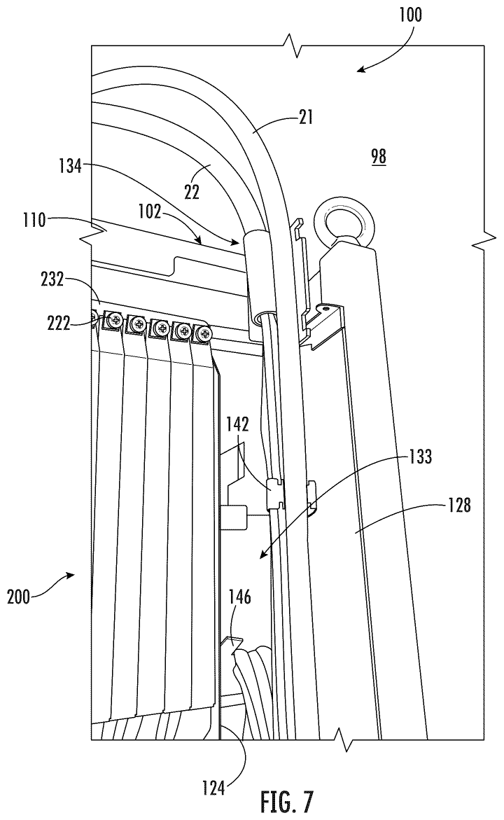

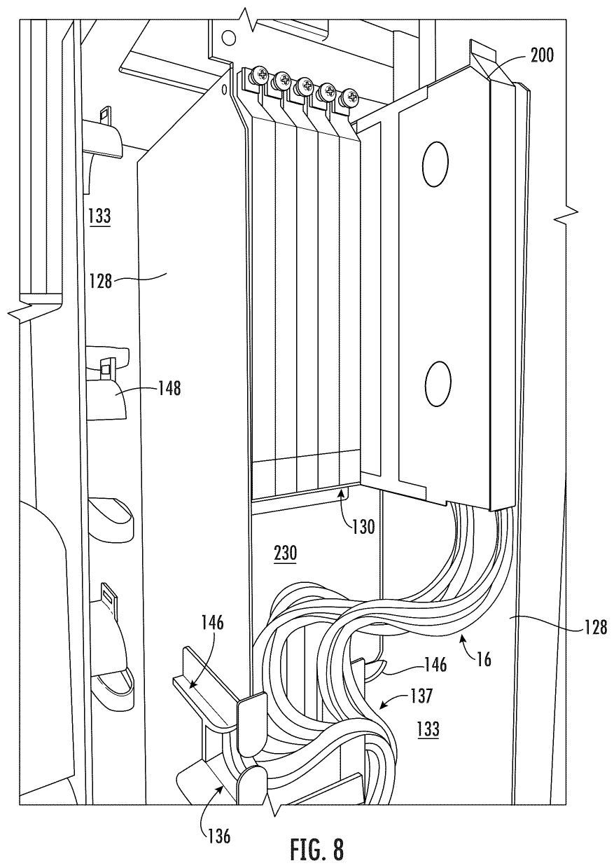

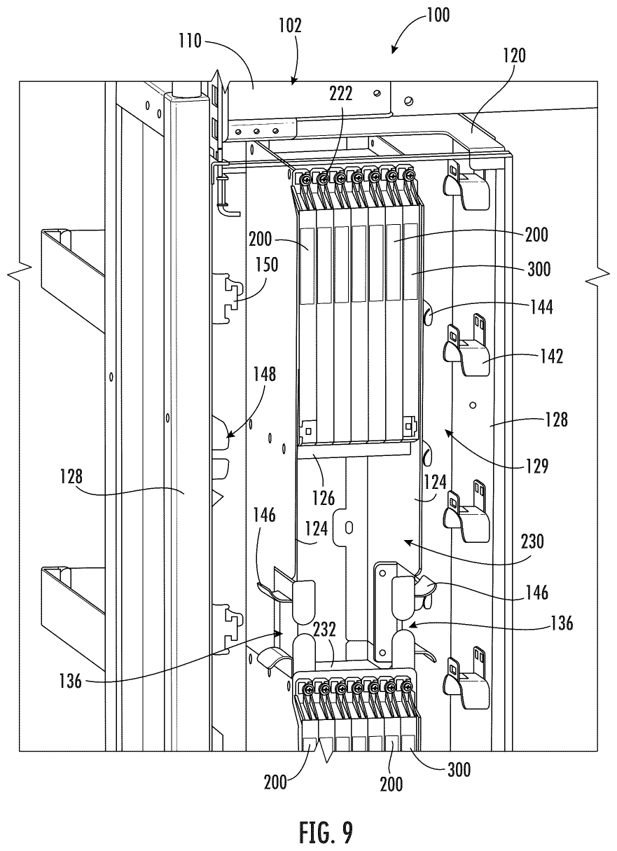

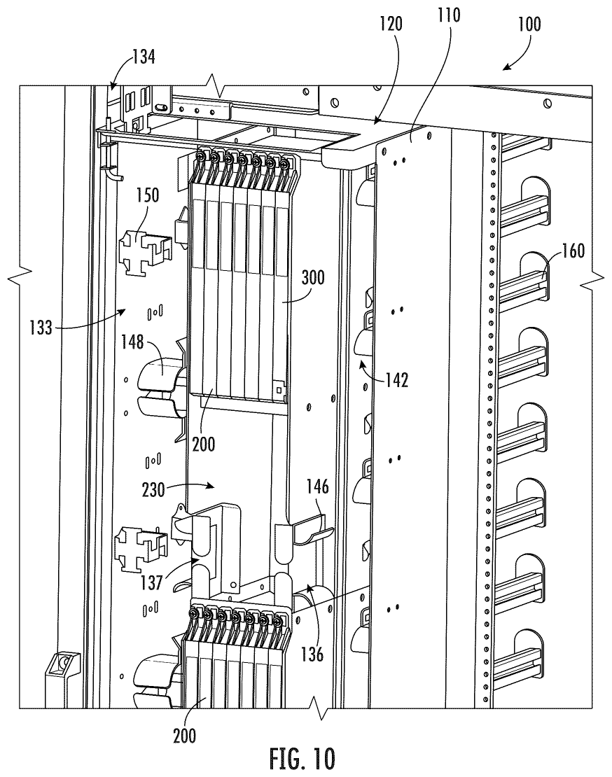

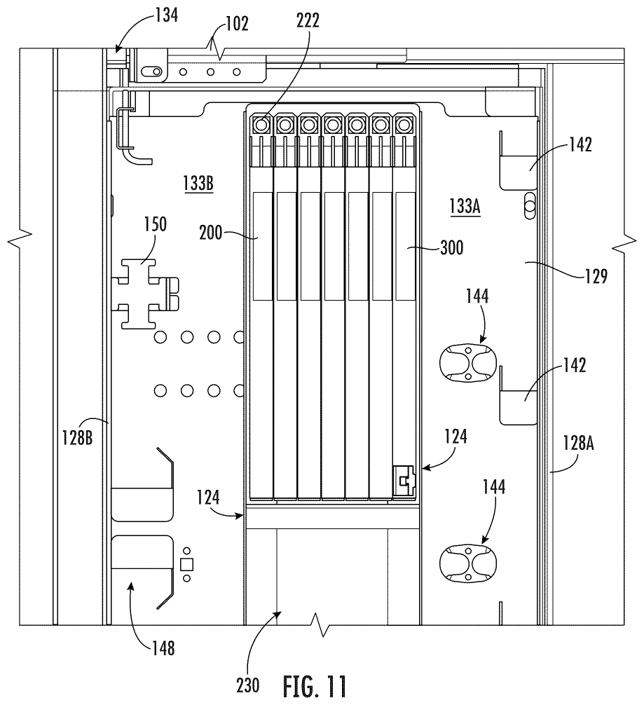

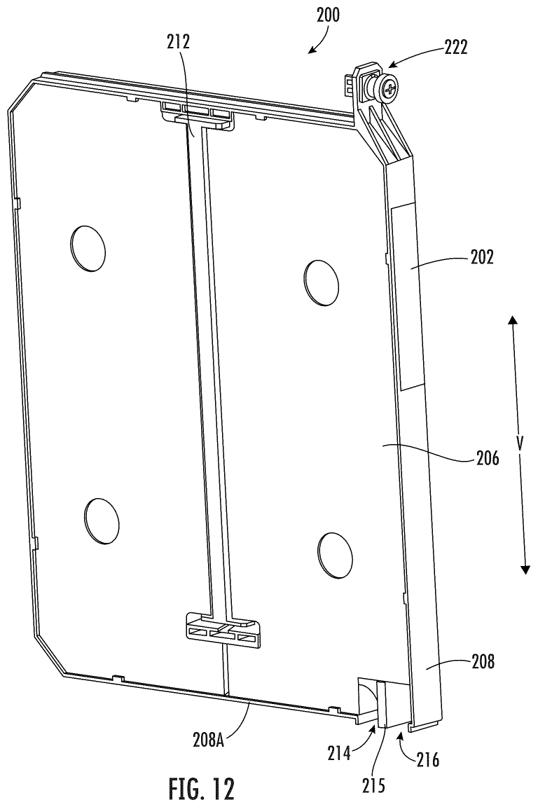

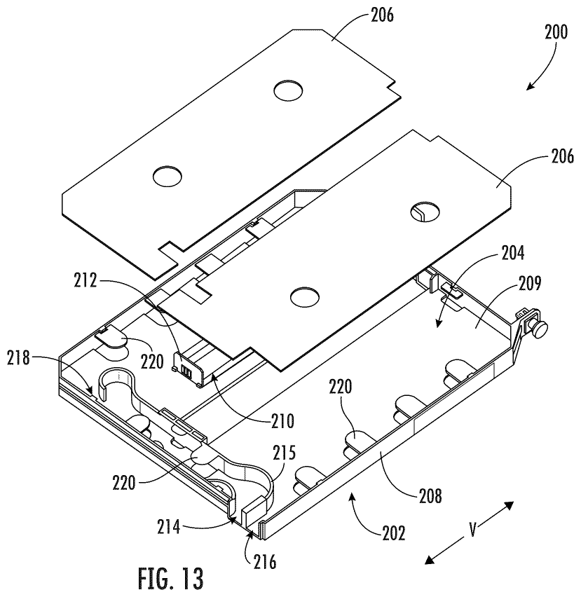

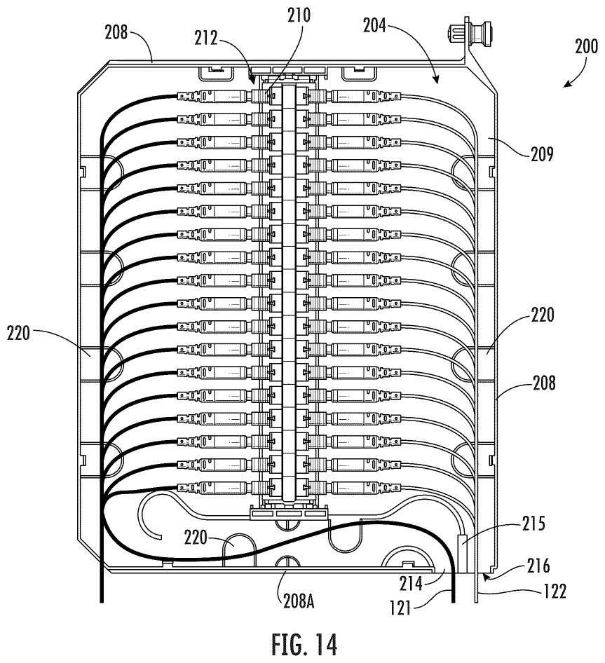

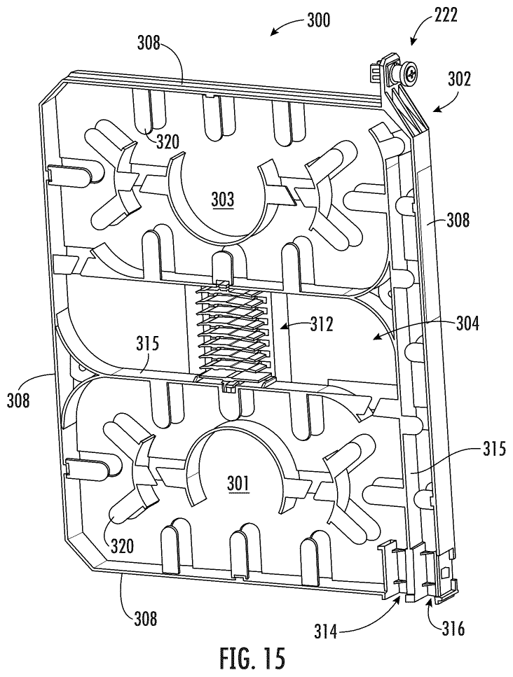

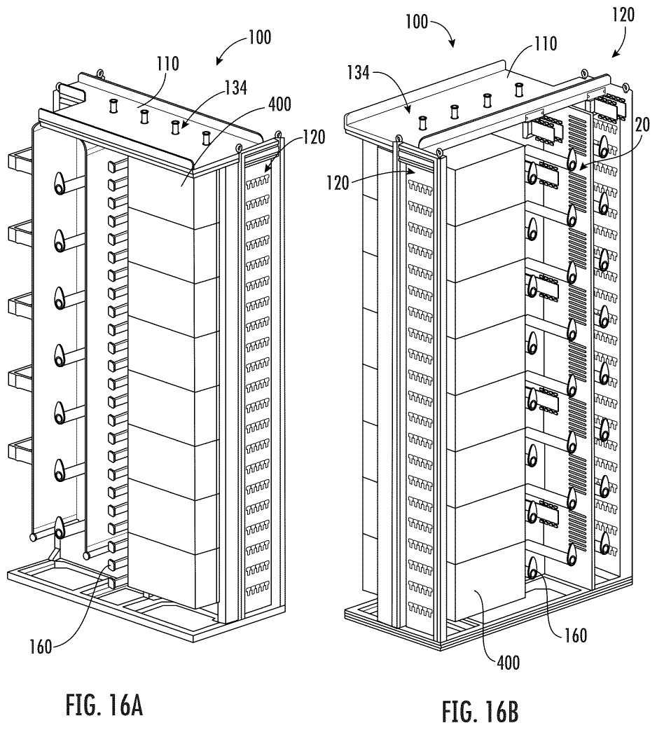

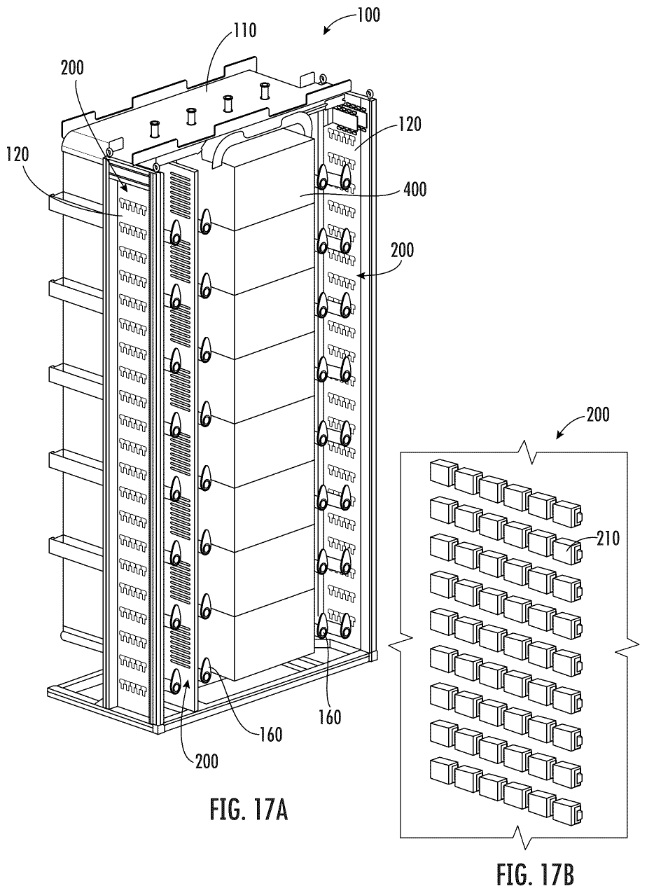

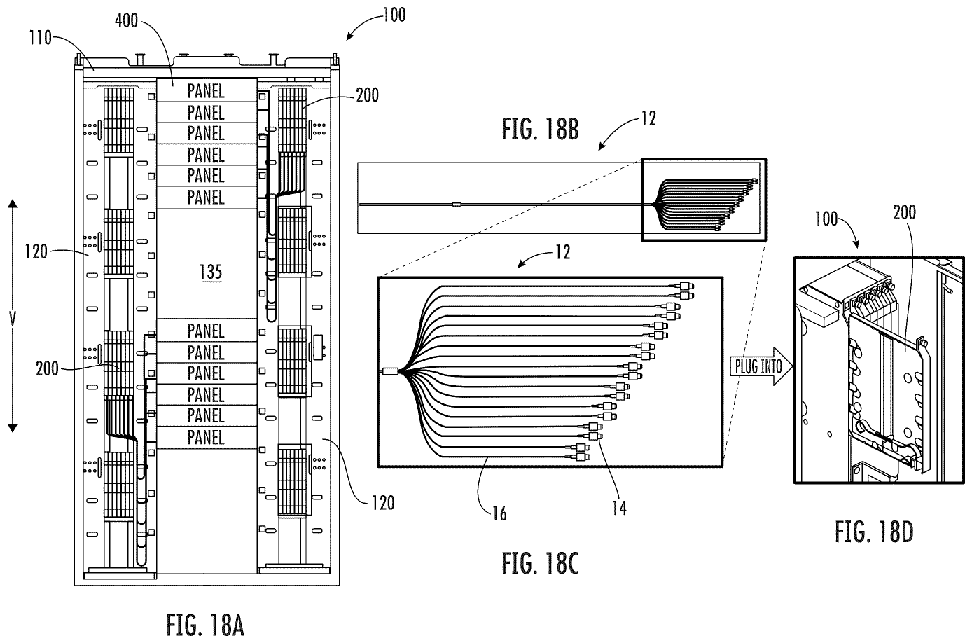

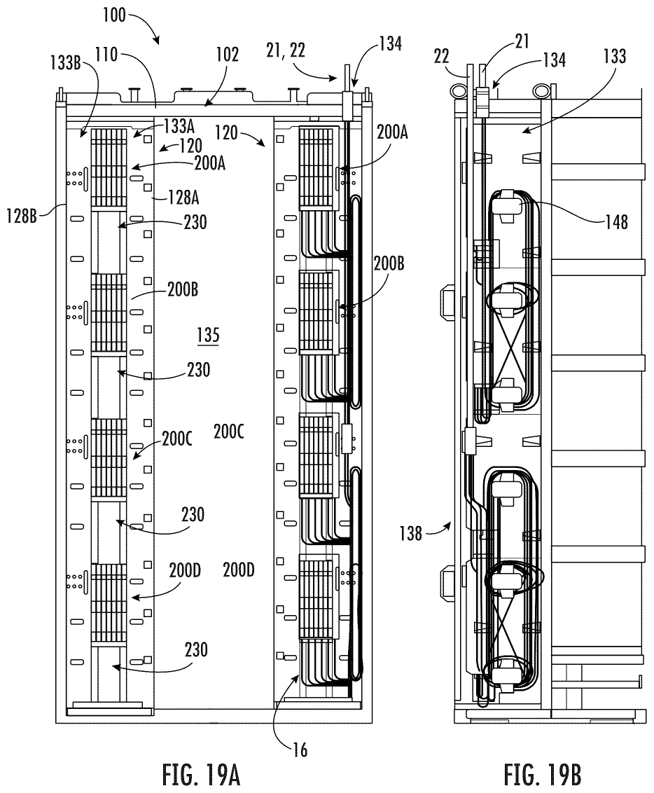

FIGS. 1-22 depict embodiments of apparatuses for mounting and routing telecommunications cables and patch panels (hereinafter, “apparatus 100”) and methods for cable routing (hereinafter, “method 1000”). Embodiments of the apparatus 100 and method 1000 provided herein facilitate improved optical network deployment and/or address one or more above identified issues. In exemplary embodiments, the apparatus 100 includes a rack or frame allowing for a cable assembly 12, such as a cable pre-terminated with one or more telecommunications connectors (e.g., MPO, SC, LC, etc.). Apparatus 100 allows pre-terminated cable 12 to route into a building and patched into one or more patch trays 200. Embodiments of apparatus 100 and/or method 1000 provided herein may allow for cable 12 to route directly to one or more adapters 210 at the patch trays 200, in contrast to splicing at a splice enclosure.

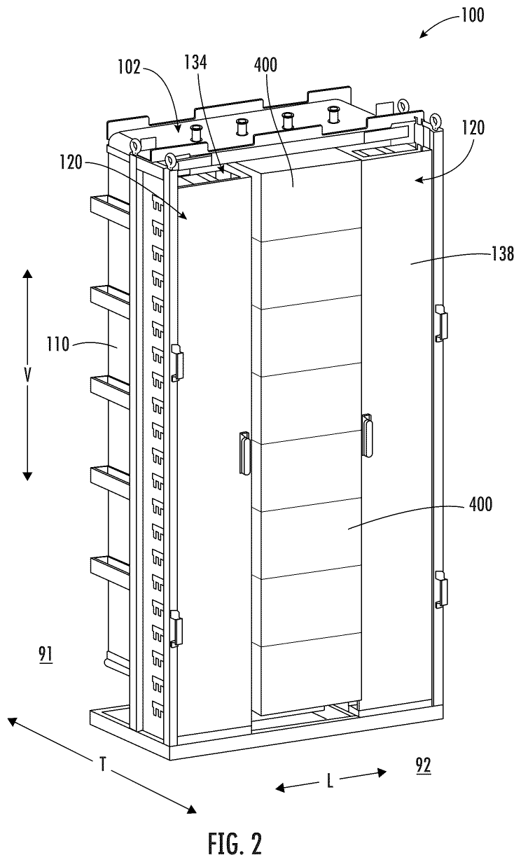

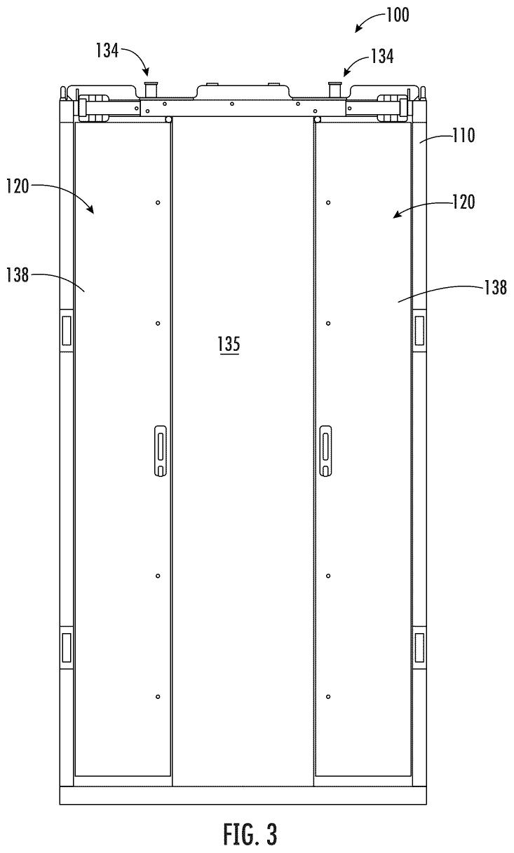

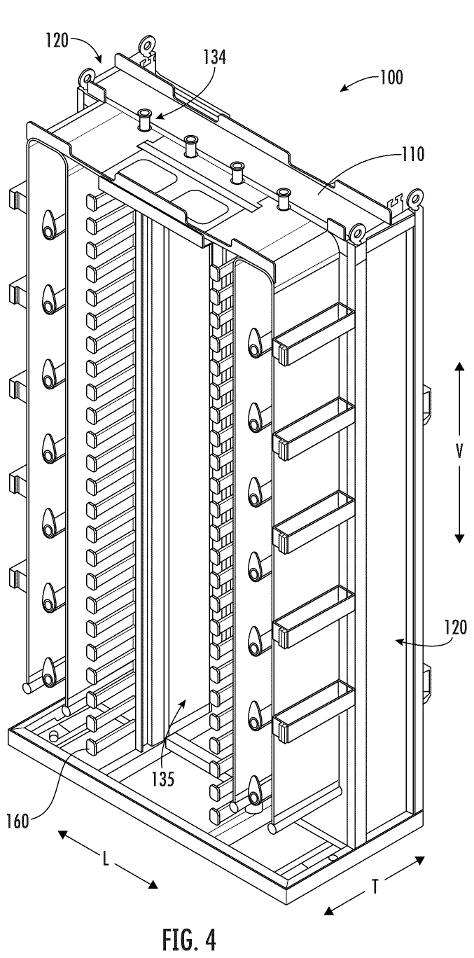

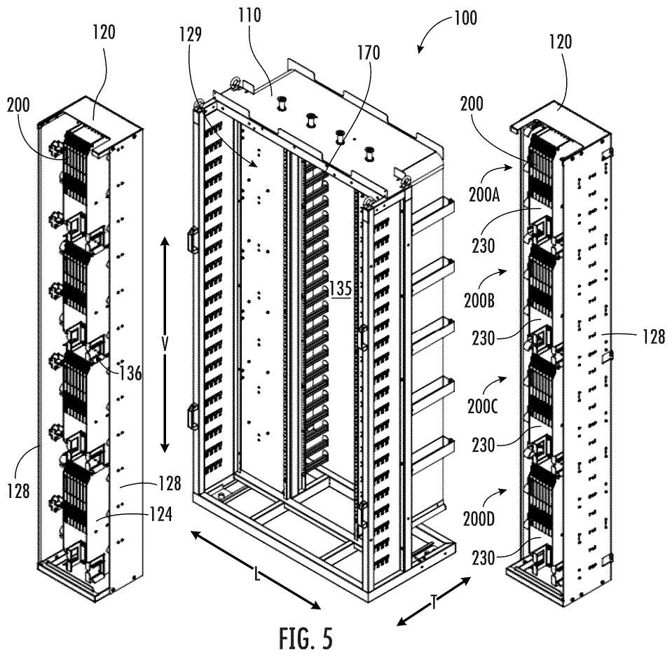

FIG. 1A and FIG. 4 depict a view of an embodiment of the apparatus 100 from a front end 91. FIG. 1B, FIG. 2, FIG. 3, and FIG. 5 depict views from a rear end 92 of embodiment of the apparatus 100. It should be appreciated that components may be removed or exploded to depict aspects of other components with further clarity.

The cable assembly 12 may generally form a pre-terminated cable including a “pigtail” or fanout assembly having a plurality of telecommunications connectors 14 (e.g., MPO, LC, SC, etc.) operably coupled to respective cable tails 16 of the cable assembly 12. In various embodiments, such as depicted herein, cable assembly 12 may include twelve (12) cable tails 16 connectable to respective patch trays 200 (e.g., connectable to twelve (12) patch trays 200).

The apparatus 100 includes a frame 110 configured to receive a cabinet 120. The cabinet 120 is configured to receive a plurality of patch trays 200 at a volume 130 (e.g., first volume). In various embodiments, the frame 110 is configured as a 48 U rack unit structure. In still various embodiments, each cabinet 120 is configured to receive twenty-four (24) patch trays 200. For instance, each cabinet 120 includes four (4) rows of patch trays 200 arranged along the vertical direction V, such as depicted at rows 200A, 200B, 200C, 200D. Each row includes six (6) or more patch trays 200 in adjacent arrangement along lateral direction L. A door 138 (e.g., FIG. 3) may be positioned to cover or obscure the patch trays 200 at the cabinet 120.

An area 135 may be formed adjacent along the lateral direction L to one or more cabinets 120. One or more patch panels 400 is positionable in the area 135, such as releasably connectable or mountable at a mount interface 160. Mount interface 160 may form an arm, rack, sidewall, or member, such as extending along the transverse direction T, to receive the patch panel 400. Mount interfaces 160 may be selectively arranged along the vertical direction V, such as to receive a plurality of patch panels 400. For instance, exemplary embodiments provided herein depict eight (8) patch panels 400 mounted to mount interfaces 160 in adjacent arrangement along the vertical direction V. However, it should be appreciated that other quantities of patch panels 400 may be incorporated. Still further, it should be appreciated that dimensions provided herein, or combinations thereof, may advantageously allow for novel and beneficial quantities and densities of cables, connections, and fiber counts at the apparatus 100, such as to allow for local and pass-through connections.

In various embodiments, the patch tray 200 is configured to receive up to 288 fibers. For instance, the patch tray 200 may be configured for 288 fiber MPO16 patching. In an exemplary embodiment, the apparatus 100 including rows and columns of patch trays 200 such as described above is configured to receive and patch up to 6912 fibers per cabinet 120. The apparatus 100 may furthermore include a first and second cabinet 120 positioned at lateral ends of the frame 110. For instance, the apparatus 100 such as described above may be configured to receive and patch up to 13824 fibers. It should be appreciated that the patch tray 200 can be configured to receive one or more of various types of telecommunications adapters 210 (e.g., MMC, SN-MT, etc.).

In various embodiments, the patch tray 200 includes a body 202 forming an interior 204. A removable cover 206 may position at the body 202 over the interior 204. For instance, the patch tray 200 may include one or more, or two, etc. portions of covers 206 positionable over the interior 204. The body 202 includes a plurality of sidewalls 208 extending from a base wall 209. The sidewalls 208 and base wall 209 form the interior 204 at which an adapter bank 212 is positioned. The adapter bank 212 includes a plurality of adapters 210 at which the cables are operably couplable.

The patch tray 200 includes a first opening 214 and a second opening 216 through which a cable enters and exits the interior 204. The openings 214, 216 are formed through the sidewall 208, or between sidewalls 208, such as at a corner of the body 202. In some embodiments, the openings 214, 216 are formed in a bottom outside corner of the body 202 relative to the patch tray 200 positioned at the cabinet 120. For instance, the openings 214, 216 are formed such that the openings are positioned proximate to a user accessing the patch tray 200 at the apparatus 100. Still for instance, the openings 214, 216 are positioned at a bottom sidewall, such as at sidewall 208A, such that cables enter and egress from along the vertical direction V.

Embodiments of the patch tray 200 may include an internal wall 215 positioned at the interior 204 and separating the first opening 214 from the second opening 216. In some embodiments, the internal wall 215 forms a passage 218 extending from the first opening 214. The passage 218 extends to route a cable from the first opening 214 to a first side of the adapter bank 212, such as depicted schematically via cable 121. The adapter bank 212 includes a plurality of adapters 210 accessible at the first side, such as proximate to the passage 218. The adapter bank 212 is further accessible at a second side, extending from the plurality of adapters 210 at the second side to the second opening 216, such as to allow a cable to extend from the adapter bank 212 and egress through the second opening 216, such as depicted schematically via cable 122. In various embodiments, the adapter bank 212 includes eighteen (18) adapters 210. However, it should be appreciated that other configurations may include other quantities of adapters or tails.

Various embodiments of the patch tray 200 may include an organizer tab 220 extending from one or more sidewalls 208 or internal wall 215, such as to provide a surface against which the cables egress and position within the interior 204.

Embodiments of the patch tray 200 include a fastener 222 releasably attachable to an attachment interface 232 at the cabinet 120. The fastener 222 may include a knob, screw, latch, clamp, or clip selectively releasable from a slot or opening 234 at the attachment interface 232. The attachment interface 232 may form a member, bar, or frame at which the opening 234 is formed. For instance, the attachment interface 232 may include a plurality of openings 234 corresponding to a quantity of fasteners 222 at the patch trays 200. In another instance, the attachment interface 232 includes the plurality of openings 234 in adjacent arrangement along the lateral direction L corresponding to the adjacent arrangement of patch trays 200 at the cabinet 120.

Embodiments of the cabinet 120 form a volume 230 (e.g., second volume) below a respective array of patch trays 200. In some embodiments, the cabinet 120 may include sidewalls 124 or base walls 126 at which arrays of patch trays 200 may be positioned. One or more of walls 124, 126 may form rails, guides, or tracks allowing for translation of the patch tray 200 out of respective tracks. The volume 230 may be formed between the base wall 126 at a first array and the attachment interface 232 at vertically adjacent second array. The plurality of sidewalls 124 at least partially forms volumes 130, 230. In some embodiments, base wall 126 extends along the transverse direction T to separate the first volume 130 from the second volume 230 and allow the opening 214, 216 at the patch tray 200 to directly fluidly communicate with the second volume 230.

In various embodiments, cables, or cable slack, may be stored in volume 230. For instance, cable slack from a respective array of patch trays 200 may be stored in a respective volume 230 positioned below the array of patch trays 200. In some embodiments, the volume 230 is configured to receive up to approximately seven (7) meters of cable tails 16 within the respective volume 230.

In some embodiments, one or more splice enclosures 300 may be included with one or arrays of patch trays 200 at the cabinet 120. The splice enclosure 300 is releasably attachable to the cabinet 120 at the volume 130. The splice enclosure 300 is releasably attachable to the cabinet 120 adjacent along the lateral direction L to the plurality of patch trays 200. For instance, the splice enclosure 300 may be included among one or more arrays of the plurality of patch trays 200.

In various embodiments, the splice enclosure 300 includes a body 302 forming an interior 304. A removable cover may position at the body 302 over the interior 304. The body 302 includes a plurality of sidewalls 308 extending from a base wall 309. A splice tray 312 is positioned at the interior 304, such as may receive any one or more structures for retaining or facilitating splicing of fiber optic leads.

The splice enclosure 300 includes a first opening 314 and a second opening 316 through which a cable enters and exits the interior 304. The openings 314, 316 are formed through the sidewall 308, or between sidewalls 308, such as at a corner of the body 302, such as described in regard to openings 214, 216, such as at a bottom outside corner of the body 302 relative to the splice enclosure 300 positioned at the cabinet 120.

Embodiments of the splice enclosure 300 may include an internal wall 315 positioned at the interior 304 and separating the first opening 314 from the second opening 316. In some embodiments, the internal wall 315 may divide the interior 304 into two or more slack routing areas 301, 303.

Various embodiments of the splice enclosure 300 may include an organizer tab 320 extending from one or more sidewalls 308 or internal wall 315, such as to provide a surface against which the cables egress and position within the interior 304.

Embodiments of the splice enclosure 300 may include a fastener 222 such as depicted and described in regard to the patch tray 200.

In various embodiments, the cabinet 120 includes a plurality of exterior sidewalls 128. The plurality of exterior sidewalls 128 at least partially surrounds the plurality of cabinet sidewalls 124.

In still various embodiments, the apparatus 100 forms a volume 133 (e.g., a third volume) between the frame 110 and the cabinet 120. For instance, the volume 133 may be formed between walls 124 128. The apparatus 100, such as the frame 110, the cabinet 120, or both, forms an opening 134 (e.g., a cable pass-through opening) extending into the volume 133. For instance, the opening 134 provides fluid communication from an exterior 98 of the frame 110 to the volume 133 formed between the sidewalls 124, 128. In some embodiments, opening 134 is positioned at a top wall 102 of the apparatus 100. For instance, opening 134 may be formed through the frame 110, the cabinet 120, or both, through the top wall 102. However, in some embodiments, opening 134 may be formed through an upper portion of the sidewall 128, or a front or rear wall 129 of the apparatus 100.

An opening 136 (e.g., cabinet opening) is formed through at least one of the sidewalls 124. The opening 136 provides egress between volumes 133, 230. For instance, the opening 136 may provide direct fluid communication between the volumes 133, 230. In an exemplary method for egress and routing, cables (e.g., cables 21, 22) are extended or routed from the exterior 98 into the volume 133 through opening 134. Cables 21, 22 are extended between volumes 133, 230 through opening 136. Openings 214, 216, 314, 316 allow for egress between interiors 204, 304 and volume 230. For instance, openings 214, 216, 314, 316 may extend in direct fluid communication between interiors 204, 304 and volume 230. In some embodiments, a gap 137 is formed, such as to form the opening 136 as a discontinuous or open-sided hole.

In various embodiments, a plurality of mounts extends from one or more sidewalls 128, 124. The mounts extend along the lateral direction L between the exterior sidewall 128 and the cabinet sidewall 124, such as within volume 133. In still some embodiments, mounts are positioned at wall 129, such as to extend along the transverse direction T into volume 133.

In some embodiments, the mounts includes an exterior sidewall mount 142 extending from sidewall 128 into volume 133. Mount 142 may form an inside sidewall mount 142 extending into an inside volume 133A laterally inward of an outside volume 133B. The inside volume 133A may be formed more proximately to a plurality of patch panels 400 positioned between a pair of cabinets 120, such as depicted at area 135. For instance, exterior sidewalls 128 may include an inside sidewall 128A inward along the lateral direction L of an outside sidewall 128B.

In still some embodiments, the mounts may include a clamp or guide 150 extending from sidewall 128. The clamp or guide 150 may be positioned proximate along the vertical direction V to opening 134 (e.g., more proximate than one or more other mounts described herein). Guide 150 may be configured to allow one or both cables 21, 22 to extend therethrough, such as to guide cables 21, 22 extending to or from opening 134.

In yet some embodiments, the mounts may include a front or rear wall mount 144 extending into volume 133 from the front or rear wall 129. Mount 144 may be configured to allow for a cable, or fanout portions thereof, to extend therethrough, such as to guide the cable in a substantially linear direction (e.g., along the vertical direction V).

In various embodiments, the mounts may include a wrap-around mount 148 at which one or more cables 21, 22 is allowed to wrap around one or more of the mounts 148.

In still various embodiments, a mount 146 is positioned at the opening 136, such as to allow one or more cables 21, 22, or portions thereof, to wrap around the mounts 146, or to guide the cables through opening 136.

It should be appreciated that the plurality of mounts depicted and described may pluralities of the mounts 142, 144, 146, 148, 150 distributed along the vertical direction V. For instance, one or more of the mounts described herein may be positioned corresponding to an array of patch trays 200, the volume 230, or both.

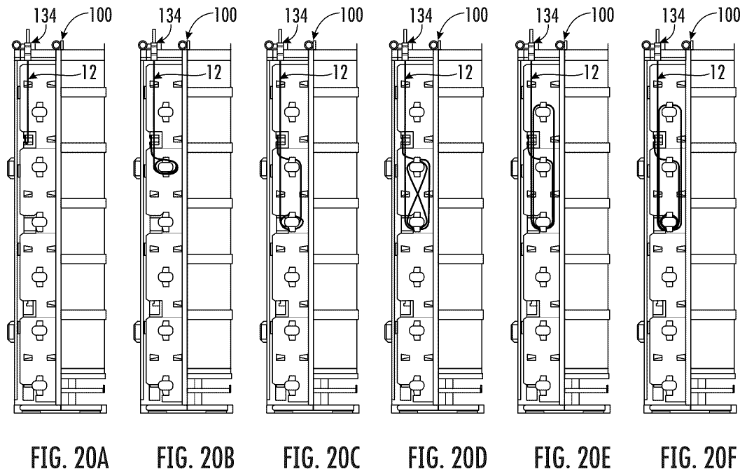

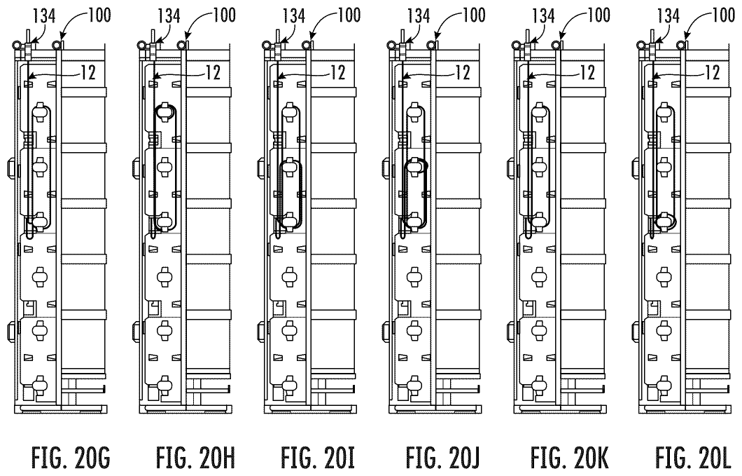

FIGS. 20A-20L depict an exemplary method for cable routing, such as at embodiments of the apparatus 100, such as described in regard to method 1000. FIGS. 20A-20L depict various embodiments of fanout cable portions extending from opening 134 into volume 133 and into a first opening 136 along the vertical direction V (e.g., proximate to opening 134) to the array of patch trays 200. For instance, a first fanout cable portion may route from opening 134 directly into opening 136 to the patch tray 200, such as depicted at FIG. 20A. A second fanout cable portion may route from opening 134 and around mount 148 or mount 142 and to opening 136, such as depicted at FIG. 20B. A third fanout cable portion may route around a pair of mounts 148 or mounts 142 and into opening 136, such as depicted at FIG. 20C. A fourth fanout cable portion may route similarly as depicted in FIG. 20C, or further including one or more cross-wise or figure-8 windings between a pair of mounts 148 or mounts 142, such as depicted at FIG. 20D. A fourth fanout cable portion may route around three (3) mounts 148 or mounts 142 and into opening 136, such as depicted at FIG. 20E. A fifth fanout cable portion may route similarly as depicted in FIG. 20E, and further include two or more wraps around one or more mounts 148 or mounts 142, such as depicted at FIG. 20F. A sixth through twelfth fanout cable portion may route similarly as depicted at FIG. 20F, and further include one or more wraps around mount 150 or mount 144. Still further, additional cable slack may be stored at volume 230. In various embodiments, apparatus 100 is configured to retain fanout cable 16 slack up to seven (7) meters or more within apparatus 100. Furthermore, various embodiments may retain such lengths of cable slack for quantities corresponding to the arrays of patch trays 200, such as described herein.

Various embodiments of the apparatus 100 described herein allow for pre-terminated high fiber count cables to route without requiring splicing, allowing for reduced field connection, labeling, and disposal time. Cables (e.g., cables 21, 22) such as described herein may form outside plant (OSP) or indoor/outdoor type cables allowing for bypass of requirements for termination within various dimensions of a building entrance (e.g., within 50 feet). Embodiments of the cable may be terminated and tested at a factory, such as to improve reliability and reduce time during field connection.

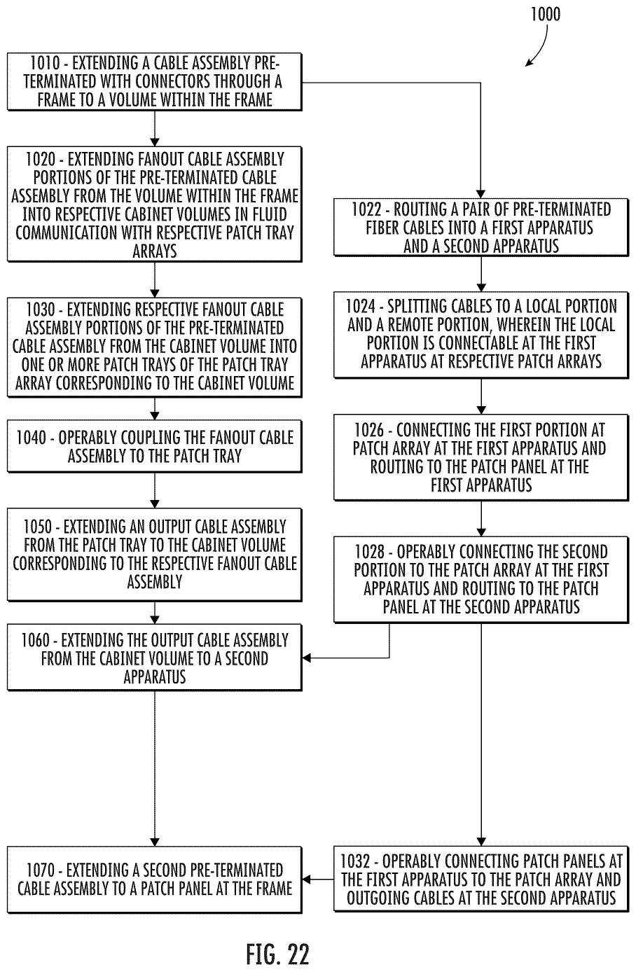

Referring now to FIG. 22, a flowchart outlining exemplary steps of a method 1000 for egress, routing, and connection of fiber optic cables, an outside plant (OSP0 cable assembly is pre-terminated with fiber optic connectors (e.g., MPO16 or other appropriate type) is provided. Method 1000 may be implemented or executed via one or more embodiments of apparatus 100, such as described herein, or other appropriate telecommunications racks, patch panels, patch trays, and the like.

Method 1000 includes at 1010 extending a cable assembly pre-terminated with connectors through a frame (e.g., frame 110) to a volume (e.g., volume 133) within the frame. For instance, the cable assembly may be a pre-terminated 3456 fiber-count cable assembly. In some embodiments, extending the 3456 fiber-count cable assembly pre-terminated with connectors through the frame to the volume within the frame includes extending a plurality of 3456 fiber-count cable assemblies totaling at least 13824 fibers through the frame.

Method 1000 includes at 1020 extending fanout cable assembly portions (e.g., tails 16 or cable portions 23) of the pre-terminated cable assembly (e.g., cable 21, 22) from the volume (e.g., volume 133) within the frame into respective cabinet volumes (e.g., volume 230) in fluid communication with respective patch tray arrays (e.g., patch tray arrays 208A, 208B, 208C, 208D, etc.). For instance, method 1000 at 1020 may include extending the cable through opening 136 or gap 137. In some embodiments, method 1000 includes a length of fanout tails up to approximately seven (7) meters. Slack or portions of the cable may be stored at cabinet volumes (e.g., volume 230).

Method 1000 includes at 1030 extending respective fanout cable assembly portions of the pre-terminated cable assembly from the cabinet volume (e.g., volume 230) into one or more patch trays (e.g., patch tray 200) of the patch tray array corresponding to the cabinet volume. For instance, method 1000 at 1030 may include extending the cable from volume 230 through opening 214, 216 into interior 204 or from interior 204 to volume 230.

In some embodiments, method 1000 includes an incoming fiber optic cable having a 3456 fiber count main portion or trunk split to a first 1728 fiber count portion and a second 1728 fiber count portion. The first portion may be connected to a first apparatus 100A (e.g., a local rack) and the second portion may patch through to a second apparatus 100B (e.g., a remote rack). For instance, the apparatuses 100A, 100B may be configured in a “daisy chain” configuration in which pre-terminated cable assemblies are routed from cabinets 120 and arrays of patch trays 200A, 200B, 200C, 200D, such as described herein, and further routed through patch panels 400 forming a pass-through. The patch panels 400 may demark ultra-high fiber count (UHFC) cables (e.g., 864 fiber count and greater) to lower fiber count cables (288 fiber count or less), such as to allow for routing or feeding cable assemblies to other apparatuses 100 at a data center.

Embodiments of the apparatus 100 and method 1000 provided herein may include routing a UHFC cable including at 432 fibers or more. The method 1000 may include splitting the fibers and terminating a first portion thereof at the first apparatus 100A and a second portion (e.g., the remainder of fibers) route and patch to a pass-through patch panel 400 and connect to the second apparatus 100B rack using a lower fiber count cable (e.g., 144 fibers or more).

In various embodiments, the fiber capacity of the apparatus 100 (e.g., a first apparatus 100A) is greater than the quantity of fibers provided to the front panel. In some embodiments, the front panel receives 6912 fibers. In such embodiments, 3456 fibers patch through the arrays of patch trays 200 at a second apparatus 100B such that the total capacity of the apparatus 100 is 13824 fibers.

Embodiments of the method 1000 include at 1040 operably coupling the fanout cable assembly to the patch tray (e.g., patch tray 200, or arrays thereof, such as 200A, 200B, 200C, 200D).

Embodiments of the method 1000 include at 1050 extending an output cable assembly (e.g., one or another of cables 21, 22) from the patch tray (e.g., patch tray 200 at volume 130) to the cabinet volume (e.g., volume 230) corresponding to the respective fanout cable assembly. As described above, slack or excess length may be stored at volume 230. In some embodiments, extending the output cable assembly from the patch tray to the cabinet volume corresponding to the respective fanout cable assembly includes extending one or more output cable assemblies totaling at least 6912 fibers from the frame.

In some embodiments, method 1000 includes at 1060 extending the output cable assembly from the cabinet volume to a second apparatus (e.g., second frame), such as described herein to generate a daisy chain configuration. For instance, in still some embodiments, method 1000 includes at 1070 extending a second 3456 fiber-count cable assembly pre-terminated with connectors to a patch panel at the frame.

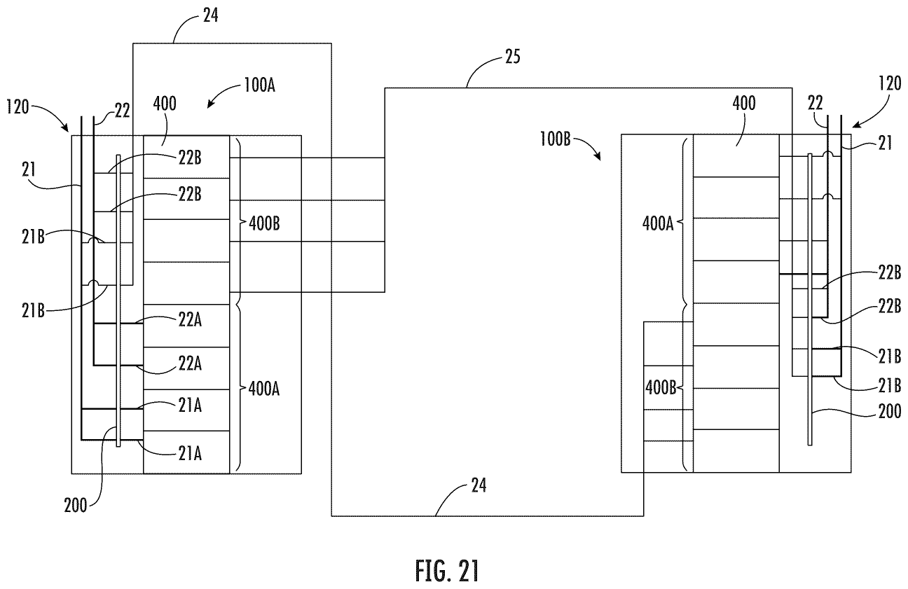

Referring to FIG. 21, an exemplary embodiment of method 1000 may include at 1022 routing a pair of pre-terminated fiber cables into a first apparatus and a second apparatus. Method 1000 at 1022 may include routing a pair of 3456 fiber cables 21, 22 into apparatus 100, such as through opening 134 such as described herein.

Method 1000 may include at 1024 splitting cables to a local portion and a remote portion. The local portion is connectable at the first apparatus at respective patch arrays. Method 1000 at 1022 may include splitting cables 21, 22 to a local portion and a remote portion, and at 1024 connecting local portion at the first apparatus 100A at respective patch arrays 200 (e.g., such as described in regard to arrays 200A, 200B, 200C, 200D) and connecting the remote portion at the second apparatus 100B at respective patch arrays 200. For instance, cables 21, 22 are split (e.g., into 1728 fiber portions) into first portion and second portion.

Method 1000 may include at 1026 connecting the first portion at patch array at the first apparatus and routing to the patch panel at the first apparatus. Method 1000 at 1026 may include locally connecting the first portion at patch array 200 at apparatus 100A and routing to patch panel 400 at apparatus 100A, such as depicted at cables 21A, 22A. In an exemplary embodiment, patch panels 400A at apparatus 100A to which cables 21A, 22A are connected may form LC panels with MPO short tail cables.

Method 1000 may include at 1028 operably connecting the second portion to the patch array at the first apparatus and routing to the patch panel at the second apparatus. Method 1000 at 1028 may include operably connecting the second portion (such as depicted at cables 21B, 22B) to patch array 200 and routing to patch panel 400 at apparatus 100B, such as depicted at cable 24. In an exemplary embodiment, cable 24 forms a 3456 fiber cable operably connected to patch panels 400B at apparatus 400B forming LC panels with MPO long tail cables (e.g., up to seven meters or more).

An exemplary embodiment of method 1000 may include at 1032 operably connecting patch panels at the first apparatus to the patch array and outgoing cables at the second apparatus. For instance, method 1000 at 1032 may include operably connecting patch panels 400B at apparatus 100A (e.g., forming LC panels with MPO long tail cables) via cable 25 (e.g., 3456 fiber cable) to patch array 200 at apparatus 100B and outgoing cables 21, 22 at apparatus 100B.

In various embodiments, the frame is a 48 U rack unit frame, and the patch tray array includes up to six patch trays. For instance, configurations described herein may include six (6) patch trays per array, with four (4) arrays per cabinet, with two (2) cabinets per apparatus 100). Still for instance, the cabinet 120 may include up to twenty-four (24) patch trays 200 distributed across the patch tray arrays.

Embodiments of the apparatus 100 and method 1000 may include one or more novel configurations, dimensions, or arrangements such as described herein to allow for increased quantities of fiber count connection, while reducing field time for connection, reducing or eliminating splicing, and increasing fiber count and reliability. It should be appreciated that the frame 100 may be configured for other rack unit dimensions. However, it should further be appreciated that combinations such as described herein may provide solutions to one or more issues such as described herein.

For instance, in exemplary embodiments, the apparatus 100 such as described herein may further include the splice enclosure 300 at one or more arrays of patch trays 200, such as to allow for splicing in the event that pre-terminated assemblies cannot be received in a desired timeframe. Additionally, or alternatively, the splice enclosure 300 may allow for splicing or repair of fiber leads that may become damaged. Volumes at the apparatus and interiors may allow for retaining and organizing large length cable tails 16 (e.g., up to seven meters or more) at each apparatus 100, while further allowing for organization to identify desired fibers.

Embodiments of the apparatus 100 may include a patch panel 400 releasably disposable at the mount interface 160 forming a rack, rail, sidewall, or arm.

In an exemplary embodiment, the apparatus 100 includes an area footprint on the ground (e.g., an area along the lateral direction and transverse direction) between approximately 600,000 square millimeters (mm²) and approximately 750,000 mm². In another exemplary embodiment, the apparatus 100 includes an area footprint between approximately 620,000 mm² and approximately 730,000 mm². In still another exemplary embodiment, the apparatus 100 includes an area footprint between approximately 630,000 mm² and approximately 720,000 mm². Various embodiments of the apparatus 100 such as described herein may include an area footprint including the frame 110 and two or more cabinets 120, such as configured as described in regard to various embodiments herein.

Embodiments such as described herein may allow for routing and connection of OSP cables while allowing for a variety of patch panel interfaces to be positioned at mount interfaces 160. Footprints such as described herein, additionally or alternatively to methods for routing, may allow for increased fiber optic connection density and pass-through configuration while decreasing area utilized at a datacenter. Embodiments provided herein may further allow for installation, removal, or replacement of patch panels of various types without requiring a change in frame.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An apparatus for telecommunications equipment mounting, the apparatus comprising:
a frame;
a cabinet releasably attachable to the frame, the cabinet forming a volume positioned adjacent along a vertical direction to a cabinet base wall separating the cabinet into a first volume and a second volume;
a plurality of patch trays releasably attachable to the cabinet at the first volume, wherein the patch tray comprises a body comprising a plurality of tray sidewalls and a tray base wall, the plurality of sidewalls and the base wall forming an interior, wherein an adapter bank is positioned in the interior, and wherein an opening is positioned at a bottom outside portion of the body relative to a transverse direction of the apparatus, the opening adjacent along the vertical direction to the second volume formed at the cabinet.

2. The apparatus of claim 1, wherein the opening is unobstructed by the cabinet base wall when the patch tray is fully inserted into the first volume.

3. The apparatus of claim 1, wherein the opening at the patch tray is positioned outside along the transverse direction relative to a distal end of the cabinet base wall.

4. The apparatus of claim 1, the cabinet comprising a plurality of cabinet sidewalls, wherein the plurality of cabinet sidewalls at least partially forms the first volume and the second volume.

5. The apparatus of claim 1, the cabinet comprising a plurality of exterior sidewalls, the plurality of exterior sidewalls at least partially surrounding the plurality of cabinet sidewalls.

6. The apparatus of claim 5, the cabinet comprising:
a plurality of mounts extending from a respective exterior sidewall, wherein the plurality of mounts extend along a lateral direction between the exterior sidewall and the cabinet sidewall.

7. The apparatus of claim 5, the cabinet comprising:
a plurality of mounts extending from a respective cabinet sidewall, wherein the plurality of mounts extend along a lateral direction between the exterior sidewall and the cabinet sidewall.

8. The apparatus of claim 1, comprising:
a splice enclosure releasably attachable to the cabinet at the first volume, wherein the splice enclosure is releasably attachable to the cabinet laterally adjacent to the plurality of patch trays.

9. The apparatus of claim 1, the frame comprising a plurality of panel mounts positioned inward along a lateral direction from the cabinet, wherein the panel mount is configured to receive a patch panel.

10. The apparatus of claim 9, wherein the plurality of panel mounts is positioned in adjacent arrangement along a vertical direction.

11. The apparatus of claim 1, wherein the apparatus comprises an opening providing fluid communication from an exterior of the frame to a third volume formed between a cabinet sidewall and an exterior sidewall.

12. The apparatus of claim 11, the cabinet comprising a plurality of cabinet sidewalls at least partially forming the second volume, wherein a cabinet opening is formed through at least one of the plurality of cabinet sidewalls, the cabinet opening providing direct fluid communication between the second volume and the third volume.

13. The apparatus of claim 1, wherein the frame is configured as a 48 U rack unit structure, and wherein the cabinet is configured to receive at least twenty-four patch trays, and wherein each patch tray is configured for up to at least 288 fiber count patching.

14. A method for telecommunications cable routing, the method comprising:
extending a pre-terminated cable assembly through a frame to a volume within the frame;
extending fanout cable assembly portions of the pre-terminated cable assembly from the volume within the frame into respective cabinet volumes in fluid communication with respective patch tray arrays;
extending respective fanout cable assembly portions of the pre-terminated cable assembly from the cabinet volume into one or more patch trays of the patch tray array corresponding to the cabinet volume;
operably coupling the fanout cable assembly to the patch tray; and
extending an output cable assembly from the patch tray to the cabinet volume corresponding to the respective fanout cable assembly.

15. The method of claim 14, comprising:
extending the output cable assembly from the cabinet volume to a second frame.

16. The method of claim 14, comprising:
extending a second pre-terminated cable assembly to a patch panel at the frame.

17. The method of claim 14, wherein the frame is a 48 U rack unit frame, and wherein the patch tray array comprises up to six patch trays.

18. The method of claim 17, wherein the cabinet comprises up to twenty-four patch trays distributed across the patch tray arrays.

19. The method of claim 14, wherein extending the pre-terminated cable assembly through the frame to the volume within the frame comprises extending a plurality of cable assemblies totaling at least 13824 fibers through the frame.

20. The method of claim 19, wherein extending the output cable assembly from the patch tray to the cabinet volume corresponding to the respective fanout cable assembly comprises extending one or more output cable assemblies totaling at least 6912 fibers from the frame.
